(19) United States
(12) Patent Application Publication
(10) Pub. No.: US 2008/0310181 A1
(43) Pub. Date: Dec. 18, 2008

(54) Brightness with reduced optical losses

(75) Inventors: Igor Gurevich, Saarbrucken (DE); Victor Faybishenko, San Carlos, CA (US); Anatoly Pashinin, Moscow (RU); Leonid Velikov, San Carlos, CA (US); Boris Zubov, Moscow (RU)

Correspondence Address: Leonid Velikov, 1371 Greenbrier Rd., San Carlos, CA, 94070, US

(73) Assignee: Microalign Technologies, Inc.

(21) Appl. No.: 11/818,559

(22) Filed: Jun. 15, 2007

(51) Int. Cl. G02B 6/04

(52) U.S. Cl. 362/554

(57) ABSTRACT

A fiber-bundle illumination system of high brightness with reduced optical losses comprises a plurality of light sources that emit lights of different colors and transmit the component lights of different colors to a light mixer through individual optical-fiber light guides assembled into a bundle, which is crimped at least at the inlet and outlet ends. Unique features of the system are optical coupling between the light sources and their respective light guides and mixing colors in a predetermined proportion that results in spatially uniform distribution of the spectrum on the illuminated area. The system may be used in conjunction with optical instruments such as endoscopic cameras, microscopes, etc.

### FIELD OF THE INVENTION

The present invention relates to illumination systems and, more particularly, to an illumination system having a light-transmitting unit in the form of an optical-fiber bundle that delivers light from a light source to the system outlet.

### BACKGROUND OF THE INVENTION

In laparoscopy and microsurgery, optical-computed tomography, as well as in conventional and confocal optical microscopy, illumination of the object of interest is an extremely important issue. In microscopy, for example, magnification is limited not by resolution capacity of the optical system but rather by the lack of sufficient illumination. The factor of achievable illumination, in turn, depends on the brightness of a light-emitting source, and, therefore, attempts of finding ways to increase the brightness of light sources have continued for many decades.

It is known that lamps such as high-pressure short-arc xenon illuminators, which are characterized by extremely high brightness, find practical use for the aforementioned applications. More specifically, such lamps are presently used in laparoscopic and microscopic surgery, high-magnification digital microscopy, etc.

It is understood that it would be advantageous to replace high-pressure short-arc xenon lamps with solid-state light sources such as light-emitting diodes (LEDs), which are more convenient for adjusting spectral characteristics. Many attempts have been made to achieve this objective, and some of these attempts were successful for application in certain fields, but LEDs are still inferior to high-pressure short-arc xenon lamps in achieving high brightness.

For example, U.S. Pat. No. 7,029,277 issued in 2006 to I. Gofman, et al., describes a LED-based light source apparatus for a curing instrument that includes a plurality of light sources, each producing an incident light beam. The incident light beams are combined to produce a single output beam, which exhibits a broader spectral width than an incident light beam. In one embodiment of the invention, the output beam exhibits intensity over a spectral range defined by a first characteristic wavelength of a first of the plurality of light sources and a second characteristic wavelength of a second of plurality of light sources such that the intensity varies by no more than 25% over the range. In the second embodiment of the invention, including one or more blue LED light sources among a plurality of light sources, at least one white LED is included in the plurality of light sources in order to generate an output light beam having a component portion that is characterized as green. In the third embodiment of the invention, a plurality of fiberoptic bundles receives the incident light beams, and is arranged at the transmitting end so that individual fibers from the plurality of bundles are randomly combined to form a single output surface for transmitting the output beam. However, the above-described illumination system does not teach any means for mixing the spatial light spectrum.

US Patent Application No 20060237636 published in 2006 (S. Lyons, et al.) relates to an integrating chamber LED lighting device with pulse amplitude modulation for setting output color or intensity, or both. The application describes an exemplary system to provide visible lighting of a selectable spectral characteristic (e.g., a selectable color combination of light) by using an optical integrating cavity or other diffuse mixing element to combine light of different colors from different color LEDs. The system modulates the amplitude of pulsed operation of the light sources, and controls the amount of each light color supplied to the diffuse mixing element and thus the amount included in the combined light output of the system. A color sensor may provide feedback as to a color characteristic of the combined light for closed-loop control of one or more of the pulse-amplitude modulations. Examples are also disclosed that use phosphor doping of one or more of the system's reflective elements to add desired wavelengths of light to the combined output. Loss of brightness as a result of mixing light beams of different colors is the main disadvantage of the system of US Patent Application No 20060237636.

U.S. Pat. No. 6,606,332 issued in 2003 to B. Boscha describes a method and apparatus of color mixing in a laser diode system. The patent discloses a color-mixing system for use in an optical-fiber laser-diode assembly comprising at least two semiconductor laser diodes, optical-fiber light input and output couples, a system of spatial superposition of laser beams of different wavelengths with at least one semitransparent mirror, and a system for electronic control of light power in monochromatic light components to be mixed. The electronic control system makes it possible to produce a plurality of different colors. The basic colors, i.e., blue, green, and red, are produced by respective laser diode assemblies provided with means for adjusting output light power on each individual assembly. The electronic system contains a microprocessor connected to a pulse-width modulation unit capable of modulating the duration and shape of the light pulse emitted from a laser diode. This allows the selection of a required ratio of energetic brightness of light beams produced by individual laser diode assemblies. The aforementioned control of chromaticity and light power is carried out simultaneously in real time, with reproduction of perfect colors based on the use of single-mode pure stabilized and frequency doubled wavelengths with narrow line widths of the light spectra. In principle, the proposed method allows the brightness of illumination to be increased in comparison with the brightness of a separate Illumination source (laser diode) used in the disclosed setup, but the complexity of the optical scheme and expensive components (dichroic mirrors) will limit the capacity of the system if laser diodes rather than LEDs are used.

U.S. Pat. No. 7,206,133 issued in 2007 to W. Cassarly, et al., relates to a light-distribution apparatus and method for illuminating optical systems that may be used, for example, in projectors, head-mounted displays, helmet-mounted displays, rear-projection TVs, and flat panel displays, as well as in other optical systems. Certain embodiments may include prism elements for illuminating spatial light modulators, for example. Light may be coupled to the prism in some cases using fiberoptics or light guides. The optical system may also include a diffuser that appropriately scatters light in order to produce a desired luminance profile. This invention is a good example of an illumination system with spatial color mixing. Nevertheless, this illumination system has limited brightness and is intended for general illumination of large areas where brightness is not an issue.

Many illuminating systems have been developed heretofore for special applications, such as illumination systems of endoscopes, particularly medical endoscopes. Distinguishing features of their design consist of light-power channeling, e.g., by means of fiber bundles that deliver light to difficult-to-reach areas, such as to an operation site during surgery where brightness of illumination plays an important role in achieving good results.

For example, U.S. Pat. No. 6,485,414 issued in 2002 to W. Neuberger entitled “Color video diagnostic system for mini-endoscopes” discloses a color video diagnostic system for mini-endoscopes to view features of objects where access to the object is limited or where minimally invasive techniques are preferable, such as in medical or industrial applications. A black-and-white video chip mounted at the distal end of an endoscope takes an image of an object sequentially illuminated by laser diode light sources having different wavelengths. More than one laser diode may be used within a color region to provide truer color representations. A controller controls the laser diode light sources for sequentially illuminating the object by color, and a video processor responsive to the controller receives signals from the black-and-white video chip for producing a color data signal. A display displays a color image of the object. At least one diagnostic laser diode light source, which can be tunable, can be included for enhancing selected features of the object being viewed, and the diagnostic laser diode light source may emit in the visible, near infrared, or infrared wavelength regions. A beam-combining element can be included for combining light beams from the laser diode light sources for provision to a fiber light-transport element for transporting the light to illuminate the object.

Unfortunately, beam-combining elements and setup of the aforementioned illumination cannot increase brightness by combining the light beams emitted from light-emitting diodes because the optical system of the aforementioned device is characterized by high losses of luminous energy.

Other endoscopic image-processing apparatuses that incorporate illumination systems are disclosed in U.S. Pat. No. 6.389,205, U.S. Pat. No. 6.458,078, U.S. Pat. No. 6.464,631, and U.S. Pat. No. 6.749,559 issued to A. Muckner, et al. For example, U.S. Pat. No. 6,389,205 describes illumination endoscopic systems with light sources having a special control unit to control brightness. Typically, light is transmitted from a light source to a light guide that extends to the distal end of the endoscope. At least one fiber in the bundle of fibers is optically coupled at one end near the light source with a light sensor, and the light sensor cooperates with the control unit to control the brightness of the light source.

Medical research indicates that cancer can be treated more effectively when detected early and lesions are smaller or when tissue is in a precancerous stage. Although changes in the physical appearance (color and morphology) of tissue using white light are useful to accomplish more reliable and earlier detection of diseases such as cancer, various endoscopic imaging devices have been developed that have increased sensitivity to the biological composition of tissue. Just as certain morphological changes in tissue may be associated with diseases, chemical changes in cells may also be exploited for disease detection.

One such method of detecting chemical changes in tissue during an endoscopic procedure involves the use of tissue illumination at specific wavelengths or bands of light that interact with certain chemical compounds in tissue, particularly those that are associated with diseases such as cancer. For example, some endoscopic devices use light in the UV, UV/blue, or IR spectrum to illuminate tissue. These wavelengths of light are selected based on their ability to stimulate certain chemicals in tissue that are associated with disease or disease processes.

When tissue is illuminated with UV, UV/blue, or IR light (also called excitation), tissue may emit light. Images or spectra emitted from tissue (fluorescence) can be captured for observation or analysis, or both. Healthy and diseased tissues fluoresce differently; therefore the spectra of fluorescence emissions can be used as a diagnostic tool. This is a further proof of the fact that the use of a solid-state illumination system that allows control of spectral characteristics of illumination is a very important issue. However, as mentioned above, the problem of increasing brightness provided by such system remains unsolved.

### OBJECTS AND SUMMARY OF THE INVENTION

One object of the invention is to provide a compact illumination system for illuminating an object with white light obtained by mixing the light of various colors and delivering that light to a light-mixing unit from individual color light sources through optical-fiber light guides. Another object is to provide the aforementioned illumination system with an optimized spectrum of illumination. Even a further object is to provide a compact illumination system of the aforementioned type that is characterized by high brightness of the illuminating light. It is another object of the present invention to find the most optical balance between the contradicting geometrical and optical parameters of the aforementioned components from the viewpoint of minimization of luminous energy losses.

The illumination system of the invention comprises a plurality of individual light sources that emit lights of different colors to respective light guides through specific light-collecting units for transfer of the light from the light sources to a light-mixing unit where color lights are mixed to form bright white light transmitted to the object to be illuminated. Each aforementioned individual light source includes a light-emitting device, e.g., a light-emitting diode (LED). Light emitted by the LED is projected from the LED's emitter to the end face of an individual light guide through a specific and highly efficient light-collecting system of lenses. The aforementioned individual light guide may comprise a single optical fiber or a sub-bundle of several fibers. The individual light guides, or sub-bundles, associated with each LED are assembled into a common bundle. In the common bundle, the fibers can be packed into an orthogonal or hexagonal pattern, and the bundle is crimped to form a substantially circular cross-sectional configuration. The ends of the light guides that are opposite to the ends of the LEDs and that transmit lights of different colors are introduced into a light-mixing unit that mixes the color lights to produce bright white light of uniform intensity and spectrum distribution. From the outlet of the light-mixing unit, the resulting bright white light of uniform special distribution is projected to the object to be illuminated.

### BRIEF DESCRIPTION OF THE DRAWINGS

FIG. 1 is a general schematic view of the optical illumination system of the invention.

FIG. 2a is an end view of the light-transmitting bundle in the direction of the mixer, the bundle being composed of 16 individual light guides loosely arranged in a rectangular ferrule.

FIG. 2b is an end view of the light-transmitting bundle in the direction of the mixer, where individual fibers of the bundle are crimped in a rectangular ferrule.

FIG. 2c is an end view of the light-transmitting bundle in the direction of the mixer, where individual fibers are densely packed in the form of concentric circular rows.

FIG. 2d is an end view of the light-transmitting bundle in the direction of the mixer, the bundle being composed of 19 individual light guides loosely arranged in a hexagonal ferrule.

FIG. 3 is a view of the system of the invention similar to FIG. 1 but with connection of the outlet end of the bundle to an endoscopic visual camera.

FIG. 4 is a longitudinal sectional view of a light-transmitting/receiving unit with an optical light guide in the form of a single optical fiber.

FIG. 5a is a view of a light-transmitting/receiving unit similar to FIG. 3 but with an optical light guide in the form of a sub-bundle of individual optical fibers.

FIG. 5b is a view of the inlet pupil of the light guide in the direction of arrow A in FIG. 5a, the broken line showing outlines of the bundle prior to crimping.

FIG. 6 is an optical scheme of a light spectrum mixer used in the system of the invention.

FIG. 7 is an example of an arrangement of end faces of the individual light guides of different colors in the outlet pupil of the bundle.

### DETAILED DESCRIPTION OF THE INVENTION

For better understanding the principle of the present invention and terminology used in the description, it will be advantageous first to consider some theoretical aspects of the illumination system of the invention.

Let us assume that the illumination system of the invention consists of “n” LEDs, “n” individual light guides with “n” respective light-collecting units for projecting light from the LEDs to the light guides, which are then packed into a bundle that forms a common light guide. Let us further assume that the exit end face of the common compacted light guide is perpendicular to the direction of propagation of light and has a diameter “D”. For simplicity of the consideration, let us first consider the case when the individual light guides are single-fiber light guides. In this case we will assume that all the LEDs are identical, i.e., have identical spectra, their emitters are squares with a side “a”, and their surface brightness is “Bᵢ”.

With reference to the above system, it is necessary to change the condition under which the flow of luminous energy passes through all components of the optical system without loss of luminous energy in order to determine the maximum achievable surface brightness on the exit end face of the optical-fiber bundle having diameter D.

Quantitative evaluations can be made by sequentially considering energy losses in all components of the optical system.

Let us first consider the loss of energy when light is introduced from an LED to an individual light guide, e.g., a loss in coupling. Such loss consists of the following components:
Loss of luminous energy caused by absorption and scattering of light by the material of the light guide;
Loss of luminous energy resulting from the fact that the common light guide that is connected to the mixer is not a monolithic body but rather is a bundle composed of a plurality of individual compacted light guides; and
Loss of luminous energy in the light-mixing unit that levels intensity and spatial distribution of light emitted from the exit end of the bundle and that projects the light onto the object.

For analysis, let us refer to the definition of brightness. The following can be written for an LED as a light source that observes the Lambert law: φᵢ=πa²×Bᵢ, where φᵢ is radiation flow from a single LED; Bᵢ is brightness of the individual LED emitted with the emitter side “a”. It is understood that if all individual light guides are connected into a single tightly packed bundle, then without any loss the total flow radiated from the exit end of the bundle will be equal to the sum of luminous flows propagated through the individual light guides:

φ=Σᵢ₌₁ⁿ φᵢ=n×πa²×Bᵢ

In other words, it is understood that if the system operates without losses, the original brightness on the exit end of the bundle is preserved if the light-emitting area of the light source is n-times greater than the area on the end face of the individual light guide and if, for an LED, the luminous energy is transmitted through the light guides having cross sections substantially equal to the surface area of the LED emitters. This scenario can be realized only when the bundle consists of ideally packed individual light guides and when the individual light guides have square or regular hexagonal cross sections. Otherwise, the total cross section of the bundle can exceed the mere arithmetic sum of the cross sectional areas of the individual light guides. In that case, according to the law of conservation of luminous energy flow, brightness on the end face of the bundle must decrease. In order to minimize this decrease of brightness, it is necessary to pack the individual light guides of the bundle, at least at the exit end of the bundle, as tightly as possible. This can be achieved by using one of two naturally existing gapless packing patterns: orthogonal or hexagonal. It is understood that deviations from the dense packing of the individual light guides will result in the same loss of luminous energy as, e.g., in the case of light absorption.

Let us introduce the following parameter:

η=Sₑ/Sₗ,

where Sₑ=n×πa² is the total area of all LED emitters, and where Sₗ is the sum of all surface areas of the bundle that radiates all collected luminous energy. As mentioned above, the case under consideration relates to the system wherein the cross-sectional area of each individual light guide is equal approximately to the emitting surface area of the respective LED.

This means that if η is less than 1, then the following can be written based on the flow continuation condition:

φ=Σᵢ₌₁ⁿ φᵢ=n×πa²×Bᵢ=(1/η)×Sₗ×Bᵢ

In other words, effective brightness will be reduced and will correspond to

Bᵢ*=(1/η)×Bᵢ.

Let us refer to the outlet end face of the common light guide bundle as “outlet pupil of the optical system”, and the light-receiving end faces of the individual light guides as “inlet pupils of the individual light guides”. It can be shown that for effective matching of the LEDs with the respective inlet pupils (i.e., to minimize loss of luminous energy transmitted over the individual light guides from all LEDs to the outlet pupil of the optical system), the area of the inlet pupil of an individual light guide should be greater than the area of the LED emitter. On the other hand, the area of the inlet pupil of an individual light guide should not exceed the area of the LED emitter too much since this may lead to the loss of the final illumination brightness. It has been experimentally found that the diameter of the inlet pupils of the individual light guides provides efficient coupling, i.e., coupling with increased losses, if the surface area on the light-receiving end face of the individual light guide has a minimal size equal to the diagonal of the light-emitting surface and if the maximum size does not exceed 2.1 a.

The coupling loss, which constitutes the main brightness-reduction factor, is determined in accordance with the following condition:

D²ₒᵤₜ·NA²ₒᵤₜ≦D²ᵢₙ·NA²ᵢₙ

where Dₒᵤₜ is a characteristic dimension (e.g., a diagonal) of the light-source-emitting area; NAₒᵤₜ is an outlet numerical aperture of the light source; Dᵢₙ is a characteristic dimension (e.g., a diameter) of the light-receiving area of the individual light guide; and NAᵢₙ, is a numerical aperture of the inlet pupil of the individual light guide. The modern LEDs have NAₒᵤₜ that may exceed 120°.

In order to realize an energetically efficient coupling of light from an LED to a fiber with the use of any perfect optical system, it is necessary, to some extent, to increase the diameter of the inlet pupil of the individual light guide. Modern optical fiber light guides have NAᵢₙ of about 60°. It is understood that the above increase in the given diameter of the inlet pupil of the individual light guide will inevitably increase losses of light in the common light-transmitting bundle.

The optical system of the present invention makes it possible to find the most optimal balance between the contradicting geometrical and optical parameters of the aforementioned components from the viewpoint of minimizing loss of luminous energy.

Although the above consideration relates identical light sources, the conclusion will be the same for a system that contains light sources of different colors, the light of which is converted into the light of a given spectrum, e.g., white.

Given below is a practical example of the system of the invention based on the above findings for light sources of different colors that produce component lights mixed in a light mixer to form white light of high brightness.

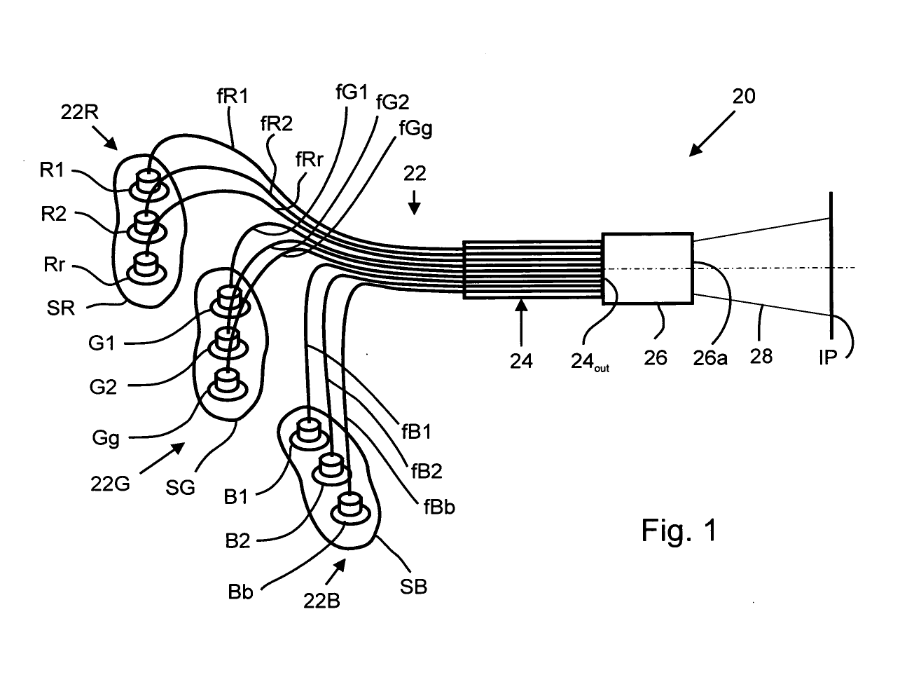

The optical system of the invention is shown as a whole in FIG. 1, which is a schematic view of the system. The system, which as a whole is designated by reference number 20, comprises a set 22 of several groups, e.g., three groups of light sources of different colors. Thus, reference numeral 22R designates a group of red light sources R1 and R2 through Rr; reference numeral 22G designates a group of green light sources G1 and G2 through Gg; and reference numeral 22B designates a group of blue light sources B1 and B2 through Bb, where indices “r”, “g”, and “b” designate the number of individual light sources in the groups of light sources of respective colors. In FIG. 1, the individual light sources are light-emitting diodes, which will be further designated as LEDs.

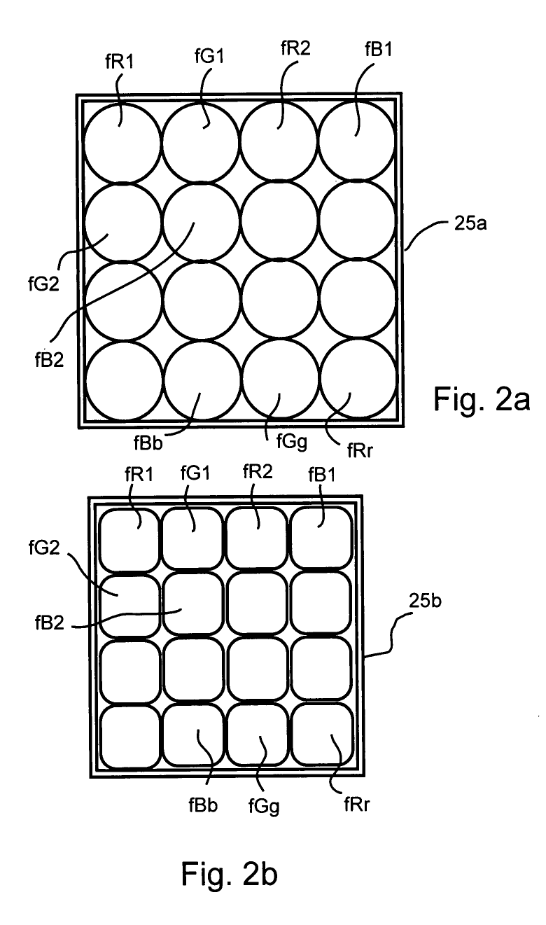

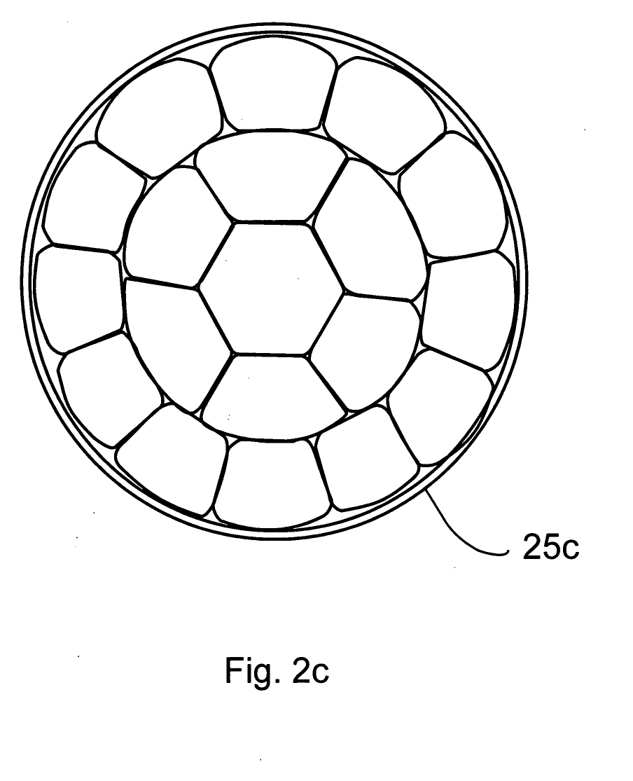

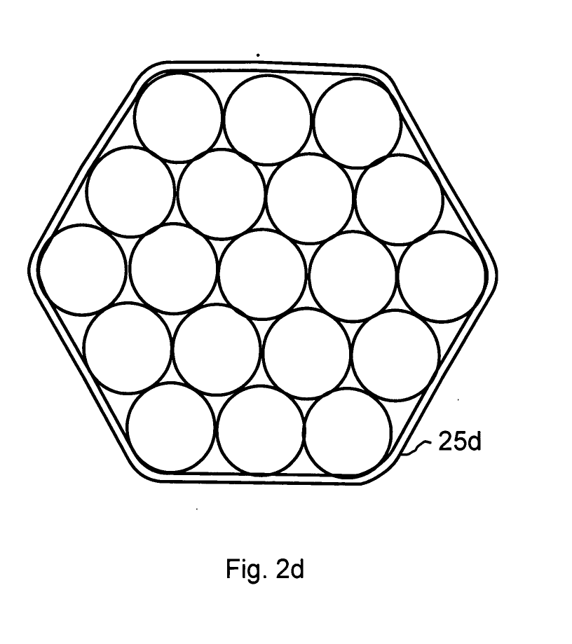

Light beams emitted from individual LEDs R1, R2, through Rr; G1, G2, through Gg; and B1, B2, through Rb are transmitted to the inlet ends of respective individual light guides fR1, fR2, through fRr; fG1, fG2, through fGg; and fB1, fB2, through fRb. These individual light guides fR1, fR2, through fRr; fG1, fG2, through fGg; and fB1, fB2, through fRb are assembled into a common light-transmitting bundle 24, which is packed, at least at the exit end 24ₒᵤₜ, to form in its cross-section an orthogonal or hexagonal pattern of the type shown in FIGS. 2a to 2d.

In the drawings, FIG. 2a is an end view of the light-transmitting bundle 24 in the direction of the mixer 26 according to one example of fiber arrangement wherein individual fibers fR1, fR2, through fRr; fG1, fG2, through fGg; and fB1, fB2, through fRb (FIGS. 1 and 2) of round cross sections just assembled into a ferrule 25a without compression. It is understood that the arrangement shown in FIG. 2a irradiates light beams of three colors (red, green, and blue) from the outlet end faces of the individual fibers. In this case, however, incomplete filling of the light-irradiating pupil will result in some loss of luminous energy.

FIG. 2b is an end view of the light-transmitting bundle 24 in the direction of the mixer 26 according to a second example of fiber arrangement where individual fibers fR1 and fR2 through fRr; fG1 and fG2 through fGg; and fB1 and fB2 through fRb (FIGS. 1 and 2) of round cross sections are assembled into a rectangular ferrule 25b and compressed to substantially square cross-sectional configurations shown in FIG. 2b. Since the fibers are densely packed, luminous energy can be transmitted with minimal loss.

FIG. 2c is an end view of the light-transmitting bundle 24 in the direction of the mixer 26 according to a third example of fiber arrangement wherein individual fibers fR1 and fR2 through fRr; fG1 and fG2 through fGg; and fB1 and fB2 through fRb (FIGS. 1 and 2) are densely packed in the form of concentric circular rows. The bundle irradiates light beams of three colors (red, green, and blue) from the outlet end faces of the individual fibers. Reference numeral 25c designates a ferrule.

The packing pattern, shown in FIG. 2c, can be obtained by compressing a bundle 24 of fibers fR1 and fR2 through fRr; fG1 and fG2 through fGg; and fB1 and fB2 through fRb (FIGS. 1 and 2) assembled into the arrangement shown in FIG. 2d. Reference numeral 25d designates a ferrule.

In the examples of fiber bundle arrangements shown in FIGS. 2a to 2d, the numbers of individual fibers fR1 and fR2 through fRr; fG1 and fG2 through fGg; and fB1 and fB2 through fRb in the bundle will correspond to the number of individual LEDs R1 and R2 through Rr; G1 and G2 through Gg; and B1 and B2 through Rb.

Although the examples of FIGS. 2a to 2d illustrate arrangements of optical fiber bundles composed of 16 fibers (FIGS. 2a and 2b) and 19 fibers (FIGS. 2c and 2d), in reality the bundles may contain numbers of fibers different from those shown in the drawings. For example, the orthogonal arrangement may contain 25 fibers, 36 fibers, etc., and the hexagonal arrangement may contain 37 fibers, 61 fibers, etc. The invention is not limited to strictly orthogonal or hexagonal packing, and in principle, any other densely packed arrangement can be used if it is in a packed and compressed form that produces a substantially circular cross section. The number of fibers is selected with reference to the number of LEDs used in each specific design.

Please note that in the examples described, the individual light guides are formed by single optical fibers. Alternatively, each individual light guide fR1 and fR2 through fRr; fG1 and fG2 through fGg; and fB1 and fB2 through fRb may comprise a sub-bundle composed of a plurality of individual fibers.

Each LED is driven from an individual power driver (not shown), and the LEDs that emit the light of the same color can be grouped on the same substrate, i.e., SR for red, SG for green, and SB for blue. However, all LEDs can be mounted on a single common substrate.

The exit end 24ₒᵤₜ, i.e., the outlet pupil of the light-transmitting bundle 24, comprises a pixel-like mosaic arrangement of end faces of individual optical fibers that transmit lights of different colors. Since the outlet end of the light-transmitting bundle 24 is crimped and the fibers are compacted, the outlet pupil of the light-transmitting bundle 24 is of a substantially round cross section, and the individual fibers are compacted to maximum possible density, which is required for decrease of losses. With normal compaction, such as shown in FIGS. 2b and 2c, the cross-sectional density of the light-transmitting bundle 24 may be about 98 to 99% of a fiber material of monolithic density.

The function of the light mixer is to mix the light of different colors transmitted by the plurality of individual light guides into a bright, spectrally optimized and spatially uniform white light which is then emitted in the form of a white light beam 28 (FIG. 1) onto the area IP to be illuminated from the outlet end face 26a of the light mixer 26.

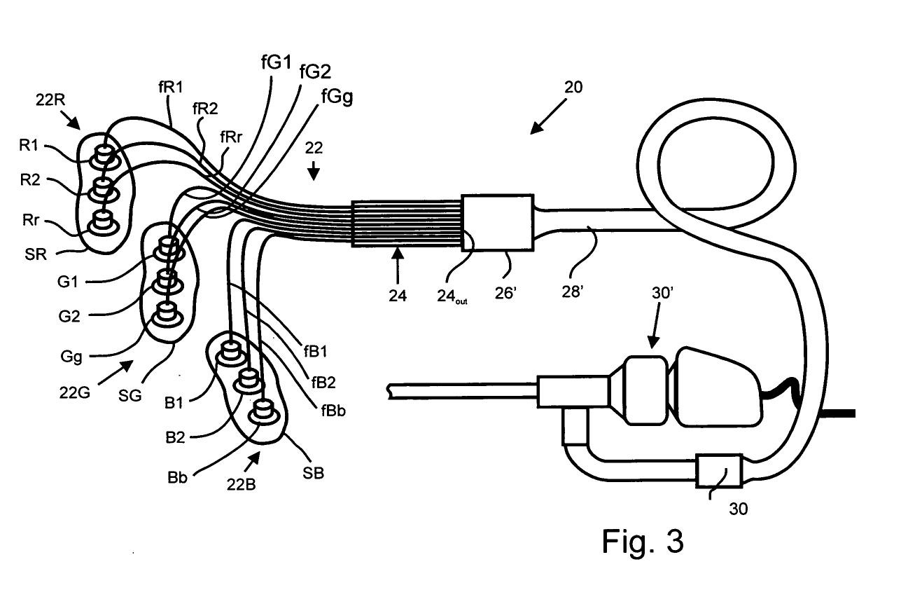

Since in reality the light-transmitting bundle 24 may be sufficiently rigid and therefore inconvenient for connection of the light mixer 26 to an optical device, such as a visual endoscopic camera or the like, the outlet end face 26a of the light mixer 26 can be connected to a flexible optical fiber bundle 28′ of the type shown in FIG. 3. The system shown in this drawing is similar to one depicted in FIG. 2. The parts and units of the system of FIG. 3 that are identical to those shown in FIG. 2 are designated by the same reference numerals. New elements in FIG. 3 are the following: a light mixer 26′, which is different from the mixer 26 in FIG. 1; a flexible optical fiber bundle 28′, and an optical connector 30, wherein, in addition to the mixing function, the mixer 26′ is provided with the function of optical matching of the light-transmitting bundle 24 with the flexible optical fiber bundle 28′. The flexible optical fiber bundle 28′ connects the light mixer 26′ with the optical connector 30, which has a standard socket for connection to an optical instrument, e.g., an endoscopic visual camera 30′. An example of the camera 30′ is a high-definition digital camera (1188 HD 3-Chip® Camera) with a rigid endoscopic objective developed by Stryker Corporation (NJ, USA). The flexible optical fiber bundle 28′ can be a corresponding cable also produced by Stryker Corporation.

Having described the optical system 20 of the invention in general, let us now consider the system components in more detail.

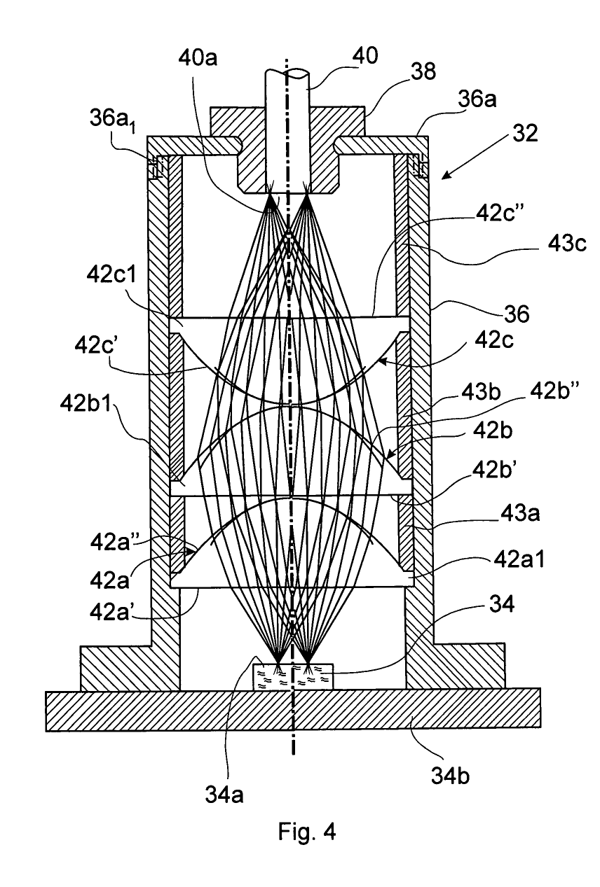

FIG. 4 is a longitudinal sectional view of a light-transmitting/receiving unit 32, which consists of an LED 34 installed on a support substrate 34b and surrounded by a cup-shaped housing 36, which can be made, e.g., of metal, ceramic, or plastic. The cup-shaped housing 36 is oriented with its bottom 36a facing up. The bottom 36a supports a centrally arranged ferrule 38 for connection of an optical light guide 40. In the embodiment of FIG. 4, the optical light guide 40 comprises a single optical fiber.

Arranged in a space between the light-emitting surface 34a of the LED emitter 34 and the light-receiving end face 40a is a group of three aspherical lenses 42a, 42b, and 42c; cylindrical flanges 42a1, 42b1, and 42c1 of the aforementioned lenses are secured by means of spacers 43a, 43b, and 43c installed inside the housing 36. In order to assemble the optical units of the lenses 42a, 42b, and 42c, the bottom 36a is removable, e.g., by means of a threaded connection 36a1. In the example of FIG. 4, all three lenses 42a, 42b, and 42c are identical. The lenses are not in contact with each other and are arranged in sequence one on top of the other. Each lens has one side flat, and the other side is convex.

Thus, the lens 42a has a flat side 42a′ and a convex aspherical surface 42a″; the lens 42b has a flat side 42b′ and a convex aspherical surface 42b″; and the lens 42c has a flat side 42c′ and a convex aspherical surface 42c″. The convex aspherical surfaces 42a″ and 42b″ face the light-receiving end face of the fiber 40, i.e., the inlet pupil of the individual light guide formed by the optical fiber 40.

The optical parameters of the lenses 42a, 42b, and 42c, the distance between the light-emitting surface 34a of the LEDs and the inlet pupil of the individual light guide 40, and the distance between the lenses and the aforementioned surfaces are selected so that the optical system of the light-transmitting/receiving unit 32 transmits the image of the LED emitter 34 with predetermined magnification to the inlet pupil of the individual light guide, which is formed by the optical fiber 40.

As a rule, this magnification is in the range of ×1.2 to ×1.5. As mentioned above, in order to diminish optical losses, the light-receiving surface area of the inlet pupil of the individual light guide 40a should exceed the light-emitting surface 34a of the emitter 34. Specific optical and geometrical parameters of the system shown in FIG. 4 are given in Table 1. Parameters in the table are given only as examples, but in each case these parameters are interrelated. It should be noted that the diameter of the individual light guide 40a, which is shown as 1 mm, is not optimal because the light guide 40 is formed by a single fiber. If the selected fiber 40 has a diameter greater than 1 mm, then it will be difficult to crimp the fibers that are collected into a tightly packed bundle.

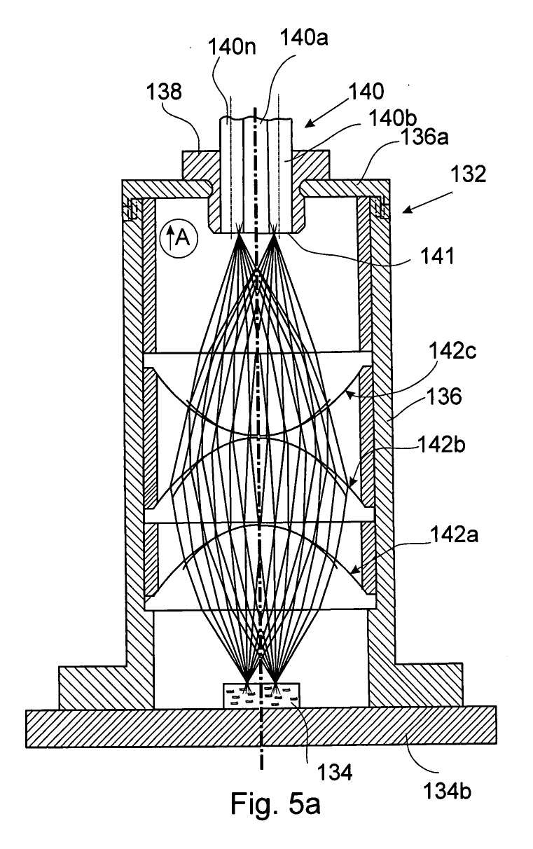

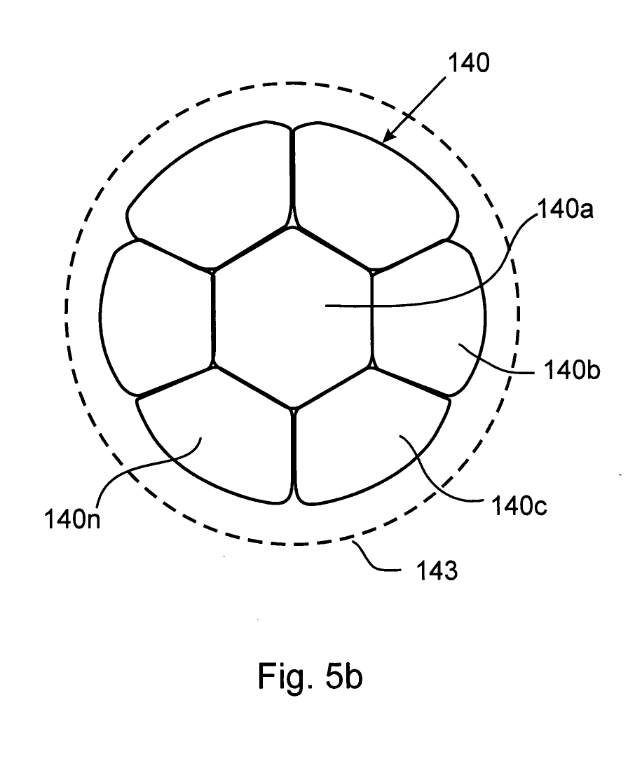

In view of the above, construction of the unit 32 can be optimized from the viewpoint of reduced coupling losses if the light-emitting/receiving device is made in the form of a unit 132, as shown in FIG. 5a. In fact, the light-emitting/receiving device 132 of FIG. 5a is essentially the same as the one shown in FIG. 4, except for the light-guide 140, which comprises a bundle of tightly packed individual optical fibers 140a, 140b through 140n. Parts of the unit 132 identical to those shown in FIG. 4 are designated by the same reference numerals with addition of 100, and their description is omitted. For example, the optical system of the unit 132 consists of an LED 134 installed on a support substrate 134b and is surrounded by a cup-shaped housing 136 which can be made, e.g., of metal, ceramic, or plastic. The cup-shaped housing 136 is oriented with its bottom 136a facing up. The bottom 136a supports a centrally arranged ferrule 138 for connection of an optical light guide 140, which in this embodiment consists of a plurality of optical fibers 140a, 140b, through 140n packed into a light-transmitting bundle. In the example of FIG. 5a, the inlet pupil or light-receiving end face 141 is greater than the inlet pupil 40a of the optical fiber bundle of the unit shown in FIG. 4.

FIG. 5b is a view on the inlet pupil 141 of the light guide 140 (FIG. 5a) in the direction of arrow A in FIG. 5a. In this example, for the sake of simplicity, the packing arrangement of the fibers consists of one central fiber 140a and a plurality of peripheral fibers 140b and 140c through 140n that surround the core fiber 140a and form a bundle of an essentially round cross section. In FIG. 5b, the dotted line 143 shows the outlines of the bundle in a loose state, i.e., prior to crimping. Although the individual light guides 140a, 140b, 140c through 140n of the sub-bundle shown in FIG. 5b may be in a loose state, crimping of the sub-bundle eliminates so-called “dead zones” in the sub-bundle cross section and actually can reduce losses of light-transmitting efficiency by about 20 to 25%. However, since after crimping the given light energy propagates through the lightguide that has a cross section smaller than in a noncrimped bundle, it becomes possible to achieve a higher value of brightness provided that in both cases the amount of light energy is the same.

Geometrical parameters and other characteristics of the LED-to-bundle coupling (FIG. 4 and FIG. 5) are shown in Table 1.

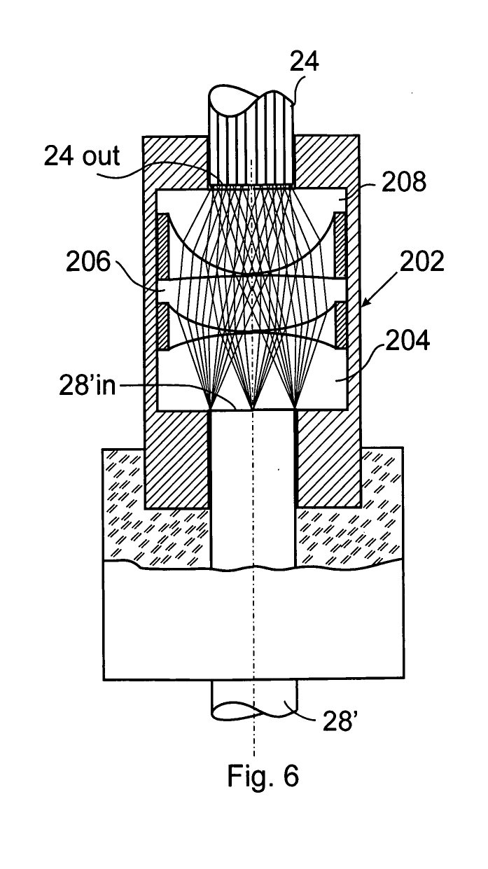

FIG. 6 is an optical diagram of the light mixer 26. In this drawing, reference numeral 24 designates the light-transmitting bundle, and reference numeral 28′ designates the flexible optical bundle for transmitting light to the object. The light mixer 26 comprises a housing 202 that supports three spherical lenses 204, 206, and 208 inserted into the housing 202. The lenses, which have predetermined radii of curvatures, thicknesses, and focal distances with respect to the end faces of the fiber bundles 24 and 28′ shown in Table 2 below, are supported by spacers 210 and 212 inside the housing 202. Reference numeral 24ₒᵤₜ designates the exit pupil of the light-transmitting bundle 24, and reference numeral 28′ᵢₙ designates the input pupil of the flexible fiber bundle 28′.

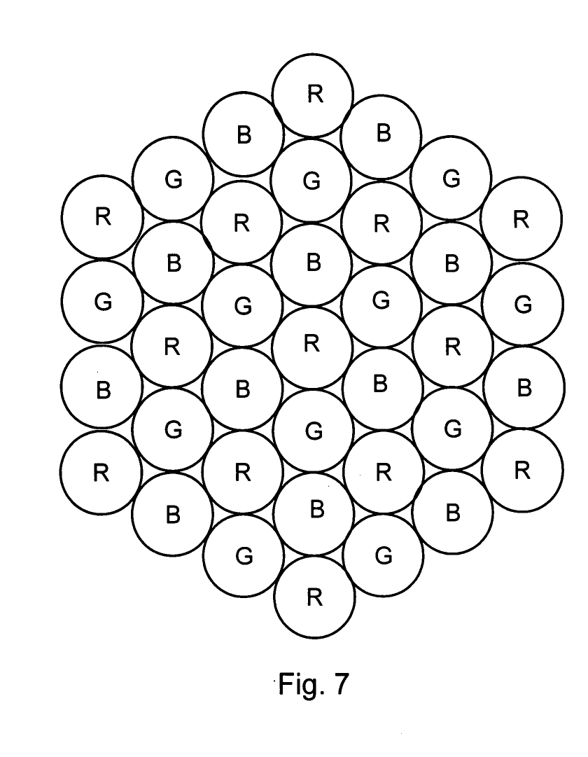

The individual light guides fR1 and fR2 through fRr; fG1 and fG2 through fGg; and fB1 and fB2 through fRb (FIG. 1) can be assembled into the bundle 22 in a predetermined regular pattern or randomly. For example, in a cross section of the bundle or in the view of the exit end 24ₒᵤₜ (outlet pupil of the optical fiber bundle 24), the pattern of the fiber arrangement may be the one shown in FIG. 7, which is a regular pattern of the fiber bundle 24 prior to crimping. This arrangement shows end faces of individual light guides that receive light from 13 red LEDs, 12 green LEDs, and 12 blue LEDs. In the example shown in FIG. 7, each light guide fR1 and fR2 through fRr; fG1 and fG2 through fGg; and fB1 and fB2 through fRb is an individual optical fiber. It is understood that each individual lightguide fR1 and fR2 through fRr; fG1 and fG2 through fGg; and fB1 and fB2 through fRb may comprise a packing arrangement of fibers, which, as shown in FIG. 5b, consists of one central fiber 140a and a plurality of peripheral fibers 140b and 140c through 140n that surround the core fiber 140a and form a bundle of an essentially round cross section. The aforementioned fibers 140a, 140b, and 140c through 140n must be compacted into the arrangement shown in FIG. 5b, at least at the inlet pupil or light-receiving end face 141 (FIG. 5a) and, if necessary, the bundle may be loose and have any arrangement of individual fibers to the point where they again are assembled and arranged into a pattern for preparing an outlet pupil 24ₒᵤₜ of the bundle 24 prior to connection to the light mixer 26 (26′). Similar to the embodiment in which the bundle 24 is composed of individual fibers, the bundle 24 comprises a packing arrangement of fibers which, as shown in FIG. 5b, the outlet pupil 24ₒᵤₜ may have either a regular or a random distribution of the individual fibers 140a, 140b, and 140c through 140n or sub-bundles of the type shown in FIG. 5b. In fact, in the outlet pupil 24ₒᵤₜ the individual fibers or sub-bundles may be arranged in any pattern, regular or random. In any case, the light beam 28 that exits the outlet pupil 26a of the light mixer 26 will be a beam of white light.

It is known that in order to mix red, green, and blue lights into a substantially natural white light, the color component lights must have approximately equal intensities or powers. However, existing LEDs that emit lights of different colors have light powers that significantly vary from color to color, and this variation may be in the percentage range of several hundred. Therefore, in order to achieve the above objective and to obtain in the bundle 28′ (FIG. 3) white light that is close to natural, it is necessary to use a different number of LEDs in the group of each color (red, green, and blue). If all LEDs of different colors are driven by substantially equal currents, then the number of LEDs in the groups of different colors should have approximately the following ratio: Red:Green:Blue=2:3:1. This ratio results in receiving a substantially white light of high intensity and uniform spectral characteristics at the outlet pupil 26a of the light mixer 26.

TABLE 1
LED-to-Bundle or Fiber Couplin (FIGS. 4, 5a and 5b - Assemblies 32 and 132)

| Lens | | | | | |
|---|---|---|---|---|---|
| Designation | Lens Curvature | Lens Thickness | | Input | Output |
| and Type | Radius (mm) | or Gap (mm) | Lens Material | Aperture | Aperture |
| 42a, 142a | (Flat side faced | 4.50 | Polycarbonate | 6.50 | 7.50 |
| (FIG. 4) | to emitter, 42a′, | | | | |
| (aspherical, | 142a′) 0.00 | | | | |
| plano-convex) | (Aspheric, | 0.10 (gap | — | 6.50 | 7.00 |
| | convex surface) −7.20* | between 42a, | | | |
| | | 142a and 42b, | | | |
| | | 142b) | | | |
| 42b, 142b | (Flat side faced | 4.50 | Polycarbonate | 6.50 | 7.50 |
| (FIG. 4) | to emitter 42b′, | | | | |
| (aspherical, | 142b′) 0.00 | | | | |
| plano-convex) | (Aspherical, | 0.10 (gap | — | 6.50 | 7.00 |
| | convex surface) −7.20* | between 42b, | | | |
| | | 142b and 42c, | | | |
| | | 142c) | | | |
| 42c, 142c | (Aspherical, | 4.50 | Polycarbonate | 6.50 | 7.50 |
| (FIG. 4) | convex surface) +7.20* | | | | |
| (aspherical, | | | | | |
| convex-plano) | (Flat side faced | — | — | 6.50 | 7.00 |
| | to light guide | | | | |
| | inlet pupil 42c′, | | | | |
| | 142c′) 0.00 | | | | |

*aspherical surface, conic constant K = 0.9; lenses molded

TABLE 2
Bundle-to-Bundle Coupling (FIG. 6 - Light Mixer 26)

| Lens | | | | | |
|---|---|---|---|---|---|
| Reference | | | | | |
| Number, | | | | | |
| Designation | Lens Curvature | Lens Thickness | | Input | Output |
| and Type | Radius (mm) | or Gap (mm) | Lens Material | Aperture | Aperture |
| 208 (FIG. 6) | (Flat side 208a | 5.60 | — | 6.00 | 7.50 |
| (spherical, | faced to bundle | | | | |
| plano-convex) | output pupil, | | | | |
| | FIG. 5) | | | | |
| | 0.00 | | | | |
| | (Spherical | 0.10 (gap | Optical glass | 6.00 | 7.50 |
| | surface 208b | between 208 | Tφ1 (SF2) | | |
| | output pupil) | and 206) | | | |
| | −15.90 | | | | |
| 206 (FIG. 6) | (Spherical | 4.00 | Optical glass | 6.00 | 7.50 |
| (spherical, | surface 206a | | Tφ1 (SF2) | | |
| convex-convex) | faced to bundle | | | | |
| | output pupil) | | | | |
| | +10.50 | | | | |
| | (Spherical | 0.10 (gap | — | 6.00 | 7.50 |
| | surface 206b | between 206 | | | |
| | faced to mixer | and 204 | | | |
| | output pupil) | | | | |
| | −51.40 | | | | |
| 204 (FIG. 6) | (Spherical | 4.50 | Optical glass | 6.00 | 7.50 |
| (spherical, | surface faced to | | Tφ1 (SF2) | | |
| convex-plano) | bundle output | | | | |
| | pupil 204a) | | | | |
| | +6.00 | | | | |
| | (Flat side 204b) | — | — | 6.00 | 7.50 |
| | 0.00 | | | | |

Experiments show that the above results could be obtained by using six red LEDs (such as LedEngin 0.47 W@1.05 A×2.53V), nine green LEDs (such as

LedEngin 0.3 W@1.05 A×3.82V) and three blue LEDs (such as LedEngin 0.96 W @1.05 A×3.59V). The illumination system 20 of the invention (FIGS. 1 and 3) makes it possible to achieve brightness and light power equivalent to the same characteristics of Stryker X8000 light source that +is powered by a 300-watt xenon elliptical bulb by using the total number of LEDs equal to 31. Prior to use of the illumination system 20, each group of LEDs of the same or different colors (FIG. 1 or FIG. 3) is initiated and emits light from its respective emitters 34 (134) (FIGS. 4 and 5A, respectively) through the system of respective lenses, such as 42a, 42b, and 42c (142a, 142b, 142c) to the input pupils 38a (141) of the individual light guides 40 (140a). Light propagates along the light guide bundle 22 to the light mixer 26 (26′). The light mixer levels the light spectra and emits a beam of white light onto the object (not shown) directly (FIG. 1) or through a flexible light-transmitting cable 28′ (FIG. 3). The flexible cable 28′ connects the light mixer 26′ with the optical connector 30, which may have a standard socket for connection to an optical instrument, e.g., an endoscopic visual camera 30′. As mentioned above, an example of the camera 30′ is a high-definition digital camera (1188 HD 3-Chip® Camera) with a rigid endoscopic objective developed by Stryker Corporation (NJ, USA). The flexible optical fiber bundle 28′ also may comprise a corresponding cable produced by Stryker.

The light emitted from the light mixer or from the endoscopic visual camera 30′ illuminates the object of interest. This light possesses the aforementioned characteristics of high intensity, brightness, and desired spectral distribution.

Thus, it has been shown that the invention provides a compact illumination system for illuminating an object with white light obtained by mixing color lights delivered to a light mixing unit from individual color light sources through optical-fiber light guides. The invention further provides the aforementioned illumination system with optimized arbitrary spectrum of illumination light. The system is compact, simple in construction, and reliable in operation. The light has high brightness, and the system has optimal balance between the contradicting geometrical and optical parameters of the aforementioned components from the viewpoint of minimizing luminous energy losses.

Although the invention has been shown and described with reference to specific embodiments, these embodiments should not be construed as limiting the areas of application of the invention, and any changes and modifications are possible provided these changes and modifications do not depart from the scope of the attached patent claims. For example, the number of LEDs and their ratios may be different from those in the example given in the description. The individual light guides may have square cross-sections. The bundles may be compacted along the entire length. The color mixer may have a structure different from the one shown and described in the present application.

1. A fiber-bundle illumination system comprising:
at least two light sources, each of said light sources having a light-emitting area that has a dimension and irradiates light;
at least two individual light guides, each of the aforementioned individual light guides being associated with one of the aforementioned at least two light sources and having an inlet end face and an outlet end face, the aforementioned at least two light guides being arranged into a light-guide bundle at least at the outlet ends thereof, said light-guide bundle having an outlet pupil;
an optical coupling unit located between each light-emitting area and the inlet end face of the respective individual light guide; and
a light mixer, which is connected to the aforementioned outlet pupil of the light-guide bundle.

2. The fiber-bundle illumination system of claim 1, wherein the aforementioned at least two individual light sources comprise light-emitting diodes having emitters.

3. The fiber-bundle illumination system of claim 2, wherein the optical coupling unit comprises a plurality of optical lenses that transfer images of the aforementioned emitters onto the inlet end faces of the aforementioned at least two individual light guides.

4. The fiber-bundle illumination system of claim 3, wherein said at least two individual light guides being compacted at their outlet end faces.

5. A fiber-bundle illumination system comprising:
a plurality of light-emitting diodes, each of said light-emitting diodes having an emitter that irradiates light, said emitter having dimensions;
a plurality of individual light guides, each of the aforementioned individual light guides being associated with one of the aforementioned light-emitting diodes and having an inlet end face and an outlet end face, the aforementioned light guides being arranged into a light-guide bundle at least at the outlet ends thereof, said light-guide bundle having an outlet pupil;
an optical coupling unit located between each emitter and the inlet end face of the respective individual light guide; and
a light mixer, which is connected to the aforementioned outlet pupil of the light-guide bundle.

6. The fiber-bundle illumination system of claim 5, wherein the optical coupling unit comprises a first aspherical optical lens having a first convex surface, a second aspherical optical lens having a second convex surface, and a third aspherical optical lens having a third convex surface, of which the first aspherical optical lens, which is nearest the respective emitter, has said first convex surface facing the inlet end face of the respective individual light guide; the third aspherical lens, which is nearest the inlet end face of the respective individual light guide, has the third convex surface facing the emitter of the respective light source; and the second aspherical lens located between the first aspherical lens and the third aspherical lens has the third convex surface facing the inlet end face of the respective individual light guide.

7. The fiber-bundle illumination system of claim 6, wherein the first aspherical optical lens, the second aspherical optical lens, and the third aspherical optical lens are identical plano-concave lenses.

8. The fiber-bundle illumination system of claim 7, wherein the individual light guides are selected from the group consisting of individual optical fibers and a sub-bundle composed of a plurality of individual fibers.

9. The fiber-bundle illumination system of claim 7, wherein the aforementioned individual light guide comprises a sub-bundle composed of a plurality of individual fibers which are compacted at least at the aforementioned inlet end face, said sub-bundle being selected from the group consisting of a sub-bundle where the individual light guides are crimped at their inlet end face and a sub-bundle where the individual light guides are loose at their inlet end faces

10. The fiber-bundle illumination system of claim 5, wherein the individual light guides in the bundle have an arrangement at the outlet pupil of the bundles selected from the group consisting of a regular pattern and a random pattern.

11. The fiber-bundle illumination system of claim 10, wherein the light-emitting diodes emit lights of different colors.

12. The fiber-bundle illumination system of claim 11, wherein said different colors are red, green, and blue colors.

13. The fiber-bundle illumination system of claim 12, wherein the color mixer mixes the red, green, and blue colors into a white color.

14. The fiber-bundle illumination system of claim 12, wherein the numbers of the light-emitting diodes of different colors should have essentially the following ratio: Red:Green:Blue=2:3:1.

15. The fiber-bundle illumination system of claim 13, wherein the numbers of the light-emitting diodes of different colors should have essentially the following ratio: Red:Green:Blue=2:3:1.

16. The fiber-bundle illumination system of claim 5, further comprising an optical connector, which has a standard socket for connection to an optical instrument.

17. The fiber-bundle illumination system of claim 7, wherein individual light guides in the bundle have an arrangement at the outlet pupil of the bundles selected from the group consisting of a regular pattern and a random pattern.

18. The fiber-bundle illumination system of claim 17, wherein the light-emitting diodes emit lights of different colors.

19. The fiber-bundle illumination system of claim 18, wherein said different colors are red, green, and blue.

20. The fiber-bundle illumination system of claim 12, wherein the light mixer mixes the red, green, and blue colors into white.

21. The fiber-bundle illumination system of claim 20, wherein the numbers of the light-emitting diodes of different colors should have essentially the following ratio: Red:Green:Blue=2:3:1.

22. The fiber-bundle illumination system of claim 19, wherein the numbers of the light-emitting diodes of different colors should have essentially the following ratio: Red:Green:Blue=2:3:1.

23. The fiber-bundle illumination system of claim 9, wherein the individual light guides in the bundle have an arrangement at the outlet pupil of the bundles selected from the group consisting of a regular pattern and a random pattern.

24. The fiber-bundle illumination system of claim 23, wherein the light-emitting diodes emit lights of different colors.

25. The fiber-bundle illumination system of claim 24, wherein said different colors are red, green, and blue.

26. The fiber-bundle illumination system of claim 25, wherein the light mixer mixes the red, green, and blue colors into white.

27. The fiber-bundle illumination system of claim 26, wherein the numbers of the light-emitting diodes of different colors should have essentially the following ratio: Red:Green:Blue=2:3:1.

28. The fiber-bundle illumination system of claim 25, wherein the numbers of the light-emitting diodes of different colors should have essentially the following ratio: Red:Green:Blue=2:3:1.
